(19) United States
(12) Patent Application Publication
(10) Pub. No.: US 2021/0200168 A1
(43) Pub. Date: Jul. 1, 2021

(54) TIME SERIES PREDICTION METHOD AND TIME SERIES PREDICTION CIRCUIT

(71) Applicant: Realtek Semiconductor Corp., HsinChu (TW)

(72) Inventors: Wen-Shan Wang, HsinChu (TW); Kuang-Yen Li, HsinChu (TW)

(21) Appl. No.: 17/136,030

(22) Filed: Dec. 29, 2020

(30) Foreign Application Priority Data
Dec. 30, 2019 (TW) 108148396

(51) Int. Cl. G05B 13/04; G05B 13/02

(52) U.S. Cl. CPC G05B 13/048; G05B 13/027; G05B 13/042

(57) ABSTRACT

The present invention provides a time series prediction method, wherein the time series prediction method includes the steps of: inputting a time series into a plurality of models to generate a plurality of predicted time series, respectively; using the plurality of models to calculate a plurality of uncertainty parameters, wherein the plurality of uncertainty parameters correspond to the plurality of predicted time series, respectively; determining a weight of each predicted time series according to the plurality of uncertainty parameters; and referring to the weight of each predicted time series to perform a weighting operation upon the plurality of predicted time series to generate a final predicted time series.

### BACKGROUND OF THE INVENTION

### 1. Field of the Invention

The present invention relates to a time series prediction method, and more particularly, to a time series prediction method with ensemble learning.

### 2. Description of the Prior Art

In general time series prediction methods, one or more models can be used to generate the predicted time series. However, in the case of using multiple models, how to generate a predicted time series with high reliability based on multiple models is an important topic.

### SUMMARY OF THE INVENTION

It is therefore an objective of the present invention to provide a time series prediction method, which can effectively generate a predicted time series with high reliability, to solve the problems described in the prior art.

According to one embodiment, a time series prediction method is disclosed, wherein the time series prediction method comprises the steps of: inputting a time series into a plurality of models to generate a plurality of predicted time series, respectively; using the plurality of models to calculate a plurality of uncertainty parameters, wherein the plurality of uncertainty parameters correspond to the plurality of predicted time series, respectively; determining a weight of each predicted time series according to the plurality of uncertainty parameters; and referring to the weight of each predicted time series to perform a weighting operation upon the plurality of predicted time series to generate a final predicted time series.

According to another embodiment, a time series prediction circuit is disclosed, wherein the time series prediction circuit comprises a plurality of prediction circuits and a calculation circuit. In the operations of the time series prediction circuit, the plurality of prediction circuits uses a plurality of models to process a time series to generate a plurality of predicted time series, respectively, and the plurality of prediction circuits use the plurality of models to calculate a plurality of uncertainty parameters corresponding to the plurality of predicted time series. The calculation circuit determines a weight of each predicted time series according to the plurality of uncertainty parameters, and performs a weighting operation on the plurality of predicted time series according to the weight of each predicted time series to generate a final predicted time series.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a time series prediction circuit according to one embodiment of the present invention.

FIG. 2 is a flowchart of a time series prediction method according to one embodiment of the present invention.

### DETAILED DESCRIPTION

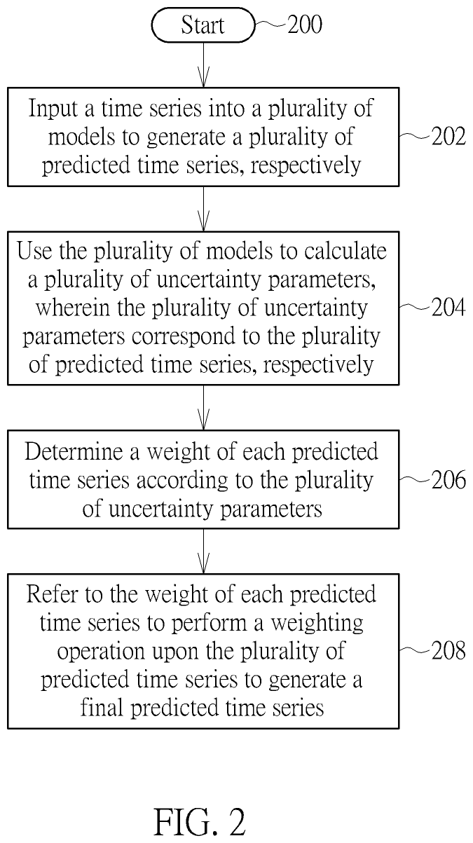

FIG. 1 is a diagram illustrating a time series prediction circuit 100 according to one embodiment of the present invention. As shown in FIG. 1, the time series prediction circuit 100 comprises a plurality of prediction circuits 110_1-110_N and a calculation circuit 120. In this embodiment, the prediction circuits 110_1-110_N have different models, for example, the prediction circuit 110_1 has a first model, the prediction circuit 110_2 has a second model, . . . , and the prediction circuit 110_N has an N^{th} model. In addition, the time series prediction circuit 100 and its internal components can be implemented by using hardware circuits, or implemented by a processor executing a program code describing a specific algorithm.

The prediction circuits 110_1-110_N may include a plurality of neural network models and/or regression models, such as Long Short-Term Memory (LSTM) neural network models, Multilayer Perceptron (MLP), other artificial neural network (ANN) models or autoregressive moving average model, etc. In one embodiment, the neural network model with different layers or different parameters can be regarded as different models, for example, the prediction circuits 110_1-110_N can be LSTM neural network models with different layers or different parameters, respectively. In another embodiment, the prediction circuits 110_1-110_N may include different types of neural network models, for example, the prediction circuit 110_1 is an LSTM neural network model and the prediction circuit 110_2 is an MLP model.

In the operation of the time series prediction circuit 100, the prediction circuits 110_1-110_N receive a time series (the same time series), respectively, and use the first model to the N^{th} model to generate a plurality of predicted time series Y1 to YN, respectively. The time series can be any time-related data, such as household expenses in a quarter of this year, specific expenses within the company, etc., and each predicted time series Y1-YN is used to indicate the data whose time point is behind the inputted time series, such as household expenses for the next quarter of this year, or specific expenses within the company. It should be noted that, it is assumed that the models in the prediction circuits 110_1-110_N have been trained with previous time series data, such as household expenses for each quarter in previous years, and specific expenses within the company. In addition, since the technical content of using models to generate predicted time series is well known to a person skilled in the art, the details of the operation of the these models will be omitted here.

In addition to the predicted time series Y1-YN, the prediction circuits 110_1-110_N also use the first model to the N^{th} model to calculate a plurality of uncertainty parameters σ1-σN corresponding to the predicted time series Y1-YN. Taking the prediction circuit 110_1 as an example, the prediction circuit 110_1 generates a plurality of test time series by hiding different nodes in the first model or ignoring different paths in the first model, and the prediction circuit 10_1 determines the uncertainty parameters σ1 of the predicted time series Y1 based on the plurality of test time series. In detail, the prediction circuit 110_1 may ignore a path of the first model and receive the time series to generate a first test time series; then the prediction circuit 110_1 ignores another path of the first model and receives the time series to generate a second test time series . . . and so on to generate the plurality of test time series, and then the prediction circuit 110_1 determines the uncertainty parameter of the predicted time series Y1 generated by the first model according to the differences between the plurality of test time series. The detailed calculation of the uncertainty parameter σ1 can refer to “Deep and Confident Prediction for Time Series at Uber” by Lingxue Zhu and Nikolay Laptev, so the details of the calculation are not described in here.

Then, the calculation circuit 120 determines weights W1-WN respectively corresponding of the predicted time series Y1-YN according to the uncertainty parameters σ1-σN, and performs a weighting operation (for example, weighted average or weighted summation) on the predicted time series Y1-YN by using the weights W1-WN to generate a final predicted time series Y_OUT. The final predicted time series Y_OUT may be calculated as follows:

$$Y\_out = \frac{Y 1 * W 2 + Y 2 * W 2 + … + YN * WN}{W 1 + W 2 + … WN} .$$

For example, assuming that the larger the values of the uncertainty parameters σ1-σN respectively represent the higher uncertainty of the predicted time series Y1-YN (that is, the lower the accuracy/reliability), the calculation circuit 120 may set the predicted time series with a higher uncertainty parameter to have a lower weight, and set the predicted time series with a lower uncertainty parameter to have a higher weight. For example, the calculation circuit 120 may use the inverse of the uncertainty parameters σ1-σN as the weight of each predicted time series Y1-YN (e.g., W1=(1/σ1), W2=(1/σ2), . . . , WN=(1/σN)).

As described above, by using the uncertainty parameters σ1-σN to generate corresponding weights to perform a weighting operation on each predicted time series Y1-YN, the final predicted time series Y_OUT generated by the time series prediction circuit 100 will have high accuracy and reliability to solve problems in the prior art.

In one embodiment, if it is known that a certain relationship exists between different time series, a prediction result of this relationship may be used to modify a loss function of the first model to the N^{th} model. Specifically, the prediction circuits 110_1-110_N and the calculation circuit 120 calculate another final predicted time series corresponding to another time series, and the prediction circuits 110_1-110_N modify the loss function of the first model to the N^{th} model according to the final predicted time series Y_OUT and the other final predicted time series. In detail, suppose there are k time series X1-Xk, and k time series X1-Xk have a known relationship as follows: Xk=X1+X2+. . . +X(k−1), the loss function L(Y_true, Y_OUT) is the mean square error (MSE) function, where “Y_true” is the actual value of the final predicted time series Y_OUT, then the loss function L(Y_true, Y_OUT) can be modified as follows: L′(Y_true, Y_OUT)=L′(Y_true, Y_OUT)+Σ|(Y_OUT1+Y_OUT2+. . . +Y_OUT(k−1))−Y_OUTk|; wherein L′(Y_true, Y_OUT) is the modified loss function, and Y_OUT1-Y_OUTk are final predicted time series generated by using the time series prediction circuit 100 to process the time series X1-Xk, respectively.

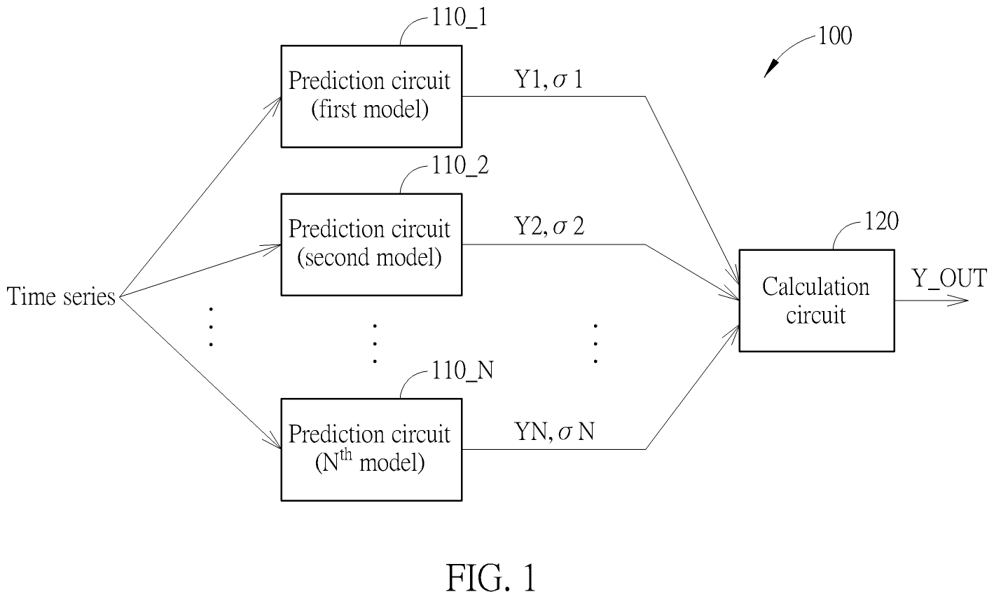

FIG. 2 is a flowchart of a time series prediction method according to one embodiment of the present invention. Referring to the description of the above embodiment, the flow of the time series prediction method is described as follows:

Step 200: the flow starts.

Step 202: input a time series into a plurality of models to generate a plurality of predicted time series, respectively.

Step 204: use the plurality of models to calculate a plurality of uncertainty parameters, wherein the plurality of uncertainty parameters correspond to the plurality of predicted time series, respectively.

Step 206: determine a weight of each predicted time series according to the plurality of uncertainty parameters.

Step 208: refer to the weight of each predicted time series to perform a weighting operation upon the plurality of predicted time series to generate a final predicted time series.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A time series prediction method, comprising:
(a) inputting a time series into a plurality of models to generate a plurality of predicted time series, respectively;
(b) using the plurality of models to calculate a plurality of uncertainty parameters, wherein the plurality of uncertainty parameters correspond to the plurality of predicted time series, respectively;
(c) determining a weight of each predicted time series according to the plurality of uncertainty parameters; and
(d) referring to the weight of each predicted time series to perform a weighting operation upon the plurality of predicted time series to generate a final predicted time series.

2. The time series prediction method of claim 1, wherein the step (b) comprises:
for a specific model of the plurality of models, generating a plurality of test time series by hiding different nodes in the specific model or ignoring different paths in the specific model; and
determining the uncertainty parameter of the predicted time series generated by the specific model according to the plurality of test time series.

3. The time series prediction method of claim 2, wherein the step determining the uncertainty parameter of the predicted time series generated by the specific model according to the plurality of test time series comprises:
determining the uncertainty parameter of the predicted time series generated by the specific model according to differences between the plurality of test time series.

4. The time series prediction method of claim 1, further comprising:
repeating steps (a)-(d) to calculate another final predicted time series corresponding to another time series; and
modifying a loss function of the plurality of models according to the final predicted time series and the other final predicted time series.

5. The time series prediction method of claim 1, wherein the plurality of models comprise a plurality of neural network models.

6. The time series prediction method of claim 1, wherein the plurality of models comprise at least one of a long short-term memory (LSTM) neural network model, a multilayer perceptron (MLP), and an autoregressive moving average model.

7. A time series prediction circuit, comprising:
a plurality of prediction circuits, configured to use a plurality of models to process a time series to generate a plurality of predicted time series, respectively, and use the plurality of models to calculate a plurality of uncertainty parameters corresponding to the plurality of predicted time series; and
a calculation circuit, coupled to the plurality of prediction circuits, configured to determine a weight of each predicted time series according to the plurality of uncertainty parameters, and refer to the weight of each predicted time series to perform a weighting operation on the plurality of predicted time series to generate a final predicted time series.

8. The time series prediction circuit of claim 7, wherein for a specific prediction circuit using a specific model of the plurality of models, the specific prediction circuit generates a plurality of test time series by hiding different nodes in the specific model or ignoring different paths in the specific model; and the specific prediction circuit determines the uncertainty parameter of the predicted time series generated by the specific model according to the plurality of test time series.

9. The time series prediction circuit of claim 8, wherein the specific prediction circuit determines the uncertainty parameter of the predicted time series generated by the specific model according to differences between the plurality of test time series.

10. The time series prediction circuit of claim 7, wherein the plurality of prediction circuits and the calculation circuit further generate another final predicted time series corresponding to another time series; and the plurality of prediction circuits modifies a loss function of the plurality of models according to the final predicted time series and the other final predicted time series.

11. The time series prediction circuit of claim 7, wherein the plurality of models comprise a plurality of neural network models.

12. The time series prediction circuit of claim 7, wherein the plurality of models comprise at least one of a long short-term memory (LSTM) neural network model, a multilayer perceptron (MLP), and an autoregressive moving average model.
